(19) United States
(12) Patent Application Publication
(10) Pub. No.: US 2018/0082597 A1
(43) Pub. Date: Mar. 22, 2018

(54) ADAPTING AIRCRAFT FLIGHT PATHS

(71) Applicant: Oxcis Aviation Ltd., London (GB)

(72) Inventors: Jonathan Nicol, London (GB); Alexander Hockey-Sweeney, Singapore (SG)

(21) Appl. No.: 15/269,887

(22) Filed: Sep. 19, 2016

(51) Int. Cl. G08G 5/00

(52) U.S. Cl. CPC G08G 5/0039; G08G 5/0021

(57) ABSTRACT

A method of changing the flight path of an aircraft, the aircraft being one in a set of aircraft, each aircraft in the set having a flight path in accordance with a transit schedule, the transit schedule including required loaded periods and replaceable unloaded periods. The method comprises receiving data associated with the set of aircraft, the received data including the transit schedule of each aircraft; storing the received data in a database; receiving a request to transport a load from a requested origin to a requested destination in time frame T; comparing, at a processor, the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and changing the flight path of one of the preferred aircraft to transit from the scheduled origin to the requested origin to the requested destination to the scheduled destination during the replaceable unloaded period.

### BACKGROUND

In private aviation, passengers generally charter individual one-way flights. Private aircraft operators do not have schedules which are set months in advance like their commercial counterparts. Flights are arranged on demand and, typically, close to their departure date. As a result of this, the flight schedules are not optimised to minimise the total number of flights which take place. Occasionally, an aircraft is chartered from one airfield to another airfield, and another passenger charters the same aircraft from that other airfield elsewhere. But more often than not, an aircraft flies one way with passengers on board, and then flies back to the departure airfield with no passengers on board. At the time of writing, about 35% of all business flights in Europe fly empty which is about 139,000 flights a year. Aviation has the highest greenhouse gas emissions per passenger mile of any commonly used mode of transport. Thus, the inefficiency in privation aviation scheduling has a significant carbon footprint which is without benefit. The market has no desire for empty flights.

The aviation industry has taken steps to reduce the number of flights which are flown without passengers (so-called empty legs). If an aircraft has been chartered to transport a passenger from airfield A to airfield B, and has subsequently been chartered to transport a passenger from airfield A to airfield C, it has an empty leg in which it returns from airfield B to airfield A between the chartered flights. This empty leg is offered by the aircraft operator at a reduced rate to customers. If a customer wants to travel from airfield B to airfield A in the time frame between the already chartered flights, then this empty leg offers a cost-effective solution and one which minimises the environmental impact of the customer's flight since that flight would have been flown anyway.

Offering empty legs for sale has reduced the number of flights flown empty, but further measures need to be taken to minimise the number of air miles flown with no passengers on board so as to minimise the carbon footprint of these flights.

### SUMMARY OF THE INVENTION

According to an aspect of the invention, there is provided a method of changing the flight path of an aircraft, the aircraft being one in a set of aircraft, each aircraft in the set having a flight path in accordance with a transit schedule, the transit schedule including required loaded periods and replaceable unloaded periods, the method comprising: receiving data associated with the set of aircraft, the received data including the transit schedule of each aircraft; storing the received data in a database; receiving a request to transport a load from a requested origin to a requested destination in time frame T; comparing, at a processor, the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and changing the flight path of one of the preferred aircraft to transit from the scheduled origin to the requested origin to the requested destination to the scheduled destination during the replaceable unloaded period.

Each preferred aircraft may be capable of flying from the scheduled origin to the requested origin to the requested destination to the scheduled destination during the replaceable unloaded period of that aircraft, wherein the transit between the requested origin and the requested destination is within the time frame T.

Each preferred aircraft may be capable of being serviced by an airfield proximal to the requested origin and capable of being serviced by an airfield proximal to the requested destination.

The requested origin may be the scheduled origin. The requested destination may be the scheduled destination.

The method of changing the flight path of an aircraft may further comprise: identifying a set of departure airfields proximal to the requested origin; identifying a set of destination airfields proximal to the requested destination; selecting a departure airfield of the set of departure airfields based on selection criteria including minimising the distance between the requested origin and the departure airfield; and selecting a destination airfield of the set of destination airfields based on selection criteria including minimising the distance between the requested destination and the destination airfield.

The selection criteria for selecting the departure airfield may further include the ability of the departure airfield to service the one preferred aircraft. The selection criteria for selecting the destination airfield may further include the ability of the destination airfield to service the one preferred aircraft.

Suitably, the amended transit time is the time for the aircraft to transit from the scheduled origin to the selected departure airfield to the selected destination airfield to the scheduled destination.

The requested origin and/or requested destination may comprise one of a geographical area, a zip code and an airfield.

The time frame T may be bounded by an earliest departure time and/or a latest arrival time.

The flight path of the one preferred aircraft may be changed prior to the replaceable unloaded period of the one preferred aircraft. Alternatively, the flight path of the one preferred aircraft may be changed during the replaceable unloaded period whilst the one preferred aircraft is in flight from the scheduled origin to the scheduled destination.

The received data may include the current location of the aircraft in transit.

According to an aspect of the invention, there is provided an apparatus for changing the flight path of an aircraft, the aircraft being one in a set of aircraft, each aircraft in the set having a flight path in accordance with a transit schedule, the transit schedule including required loaded periods and replaceable unloaded periods, the apparatus comprising: a receiver configured to receive data associated with the set of aircraft, the received data including the transit schedule of each aircraft, the receiver being further configured to receive a request to transport a load from a requested origin to a requested destination in time frame T; a database configured to store the received data; and a processing system, coupled to the receiver and the database, the processing system including a processor and a memory coupled to the processor, the memory storing computer executable instructions, the processor being configured to execute the computer executable instructions to: comparing the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and changing the flight path of one of the preferred aircraft to transit from the scheduled origin to the requested origin to the requested destination to the scheduled destination during the replaceable unloaded period.

The processor may be further configured to execute the computer executable instructions to: identify a set of departure airfields proximal to the requested origin; identify a set of destination airfields proximal to the requested destination; select a departure airfield of the set of departure airfields based on selection criteria including minimising the distance between the requested origin and the departure airfield; and select a destination airfield of the set of destination airfields based on selection criteria including minimising the distance between the requested destination and the destination airfield.

According to an aspect of the invention, there is provided a non-transitory computer readable medium with computer executable instructions stored thereon, which, when executed by a processor perform a method of causing a flight path of an aircraft to be changed, the method comprising: receiving data associated with the set of aircraft, the received data including a transit schedule of each aircraft; storing the received data in a database; receiving a request to transport a load from a requested origin to a requested destination in time frame T; comparing the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and causing a change in the flight path of one of the preferred aircraft to transit from the scheduled origin to the requested origin to the requested destination to the scheduled destination during the replaceable unloaded period.

The non-transitory computer readable medium may further comprising identifying a set of departure airfields proximal to the requested origin; identifying a set of destination airfields proximal to the requested destination; selecting a departure airfield of the set of departure airfields based on selection criteria including minimising the distance between the requested origin and the departure airfield; and selecting a destination airfield of the set of destination airfields based on selection criteria including minimising the distance between the requested destination and the destination airfield.

### BRIEF DESCRIPTION OF THE FIGURES

The present invention will now be described by way of example with reference to the accompanying drawings. In the drawings:

FIG. 1 illustrates an aircraft scheduling system;

FIG. 2 illustrates a flowchart illustrating a method of changing the flight path of an aircraft;

FIG. 3 illustrates the transit schedule of an aircraft in relation to the time frame of a requested flight; and

FIG. 4 illustrates an exemplary computing-based device in which the aircraft selection method of FIG. 2 may be implemented.

### DETAILED DESCRIPTION

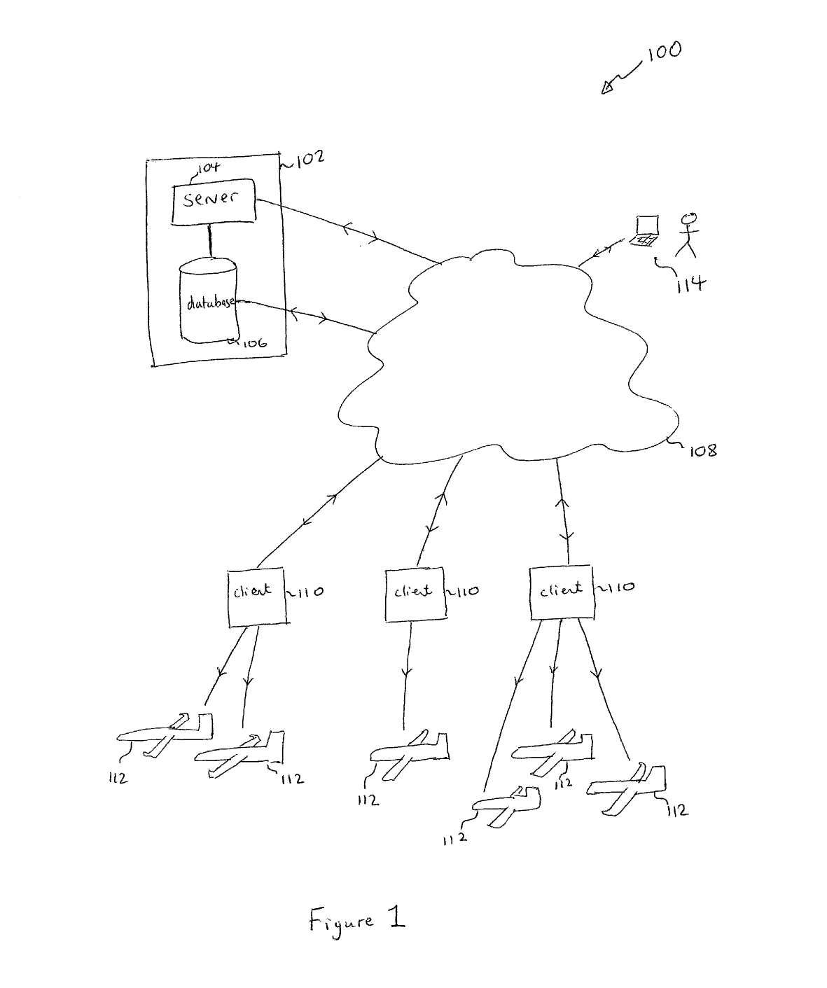

FIG. 1 is a schematic diagram illustrating an aircraft scheduling system 100. Computing system 102 comprises server 104 and database 106. Server 104 and database 106 may be co-located or in different locations. Computing system 102 is connected to user devices, such as user device 114, via internet 108. Computing system 102 is also connected via internet 108 to several aircraft operators 110. Each aircraft operator controls the flight path of one or more aircraft 112. Each aircraft operator comprises client software configured to operate cooperatively with computing system 102. Aircraft operators 110 compile and record data associated with aircraft 112. Aircraft operators 110 send this data to database 106 for storage. A user may send a request via user device 114 and internet 108 to server 104 to charter a flight. In responding to a request to charter a flight, computing system 102 determines one or more preferred aircraft for servicing the requested flight. Computing system 102 sends an instruction to aircraft operator 110 to change the flight path of one of those preferred aircraft in order to service the requested flight.

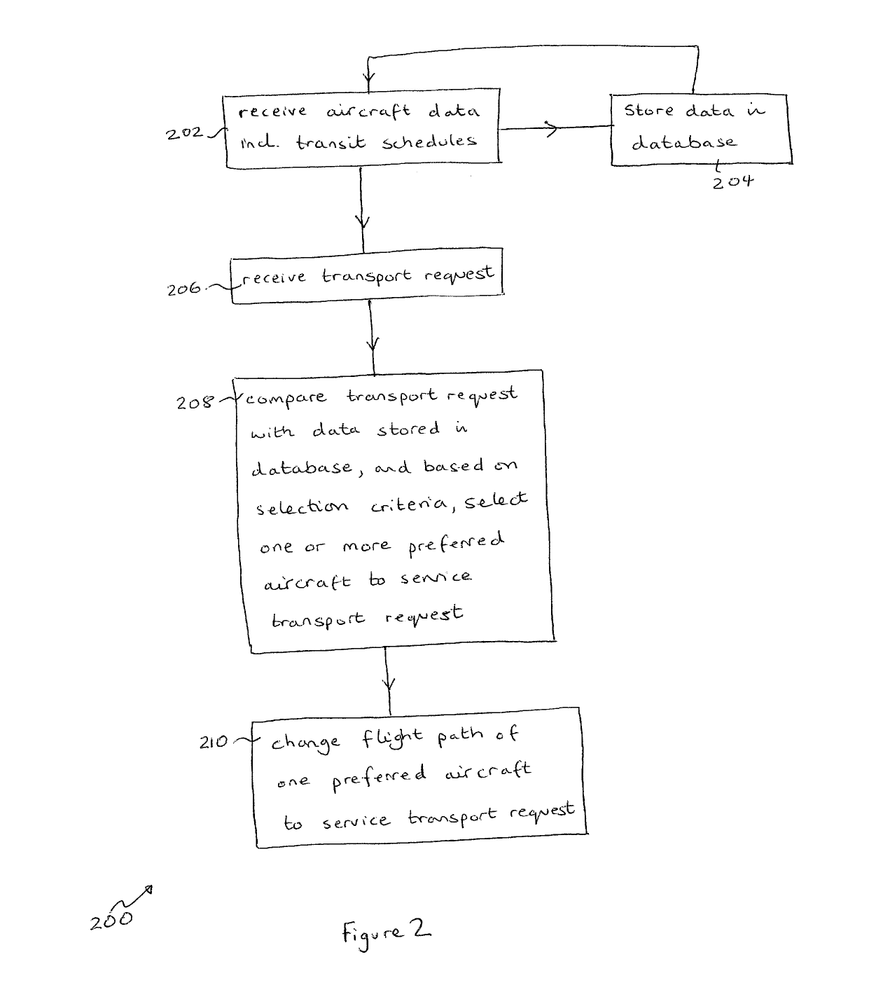

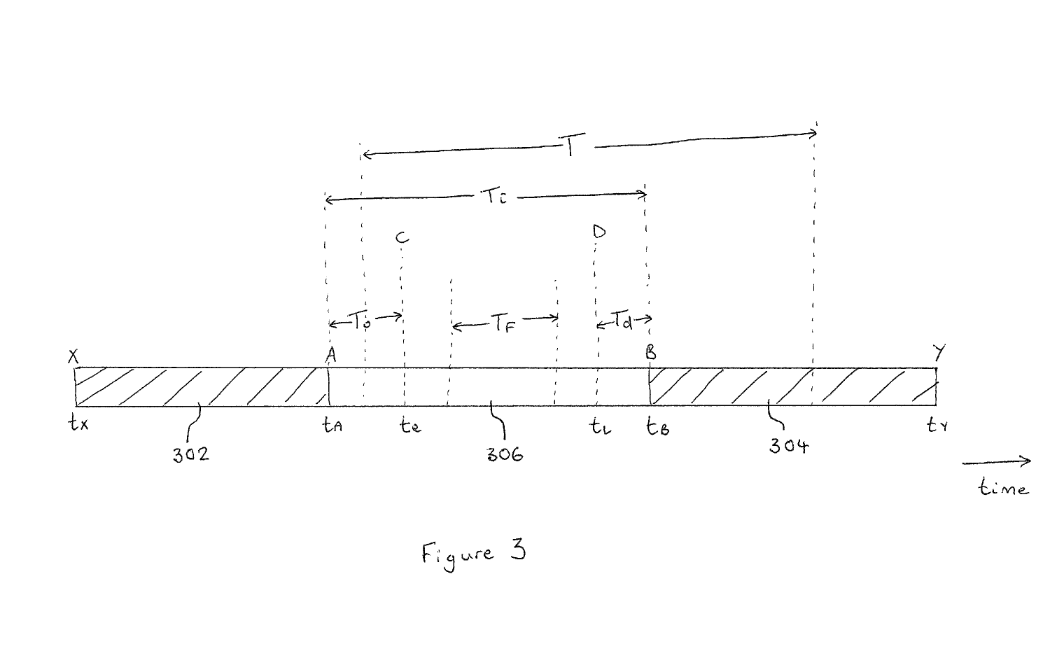

The method 200 by which the computing system determines one or more preferred aircraft for servicing the requested flight will now be described with reference to FIGS. 2 and 3.

At step 202, the computing system receives data associated with a set of aircraft. This data is sent from one or more aircraft operators 110. Data associated with the aircraft may also be sent to the computing system from other sources, such as from airfields. Each aircraft has a flight path set in accordance with a transit schedule for that aircraft. The transit schedule specifies the flights that the aircraft is scheduled to undertake. FIG. 3 illustrates a portion of a transit schedule for an exemplary aircraft. In the illustrated portion, the aircraft has three scheduled flights. The first scheduled flight is from airfield X to airfield A, departing at time t_{X} and arriving at time t_{A}. This flight is chartered and has passengers on board. The second scheduled flight is from airfield A to airfield B. This flight is not chartered. It is an empty leg. The third scheduled flight is from airfield B to airfield Y, departing at time t_{B} and arriving at time t_{Y}. This flight is chartered and has passengers on board. The chartered flights are required loaded periods 302, 304 in the transit schedule since they are carrying a load (in this case passengers) and must transit at the scheduled times. A required loaded period includes the time that the aircraft is airborne and the time that the aircraft is required to be at the airfield before take-off and after landing. The empty leg is a replaceable unloaded period 306 in the transit schedule since it is not carrying a load and the timing of the flight is changeable as long as the aircraft is at airfield B and ready to depart by t_{B}. During a replaceable unloaded period, an aircraft may be: located at an airfield ready for its next chartered flight from that airfield, or located at an airfield waiting for transit to a different airfield from which its next chartered flight is scheduled, or in transit from the destination airfield of its last chartered flight to the departure airfield of its next chartered flight. The data received by the computing system includes the transit schedules of each aircraft of the set of aircraft.

The data received by the computing system may also include other data associated with the aircraft. Examples of such data are: the dimensions of the aircraft, the weight of the aircraft, the number of passengers on board each chartered flight of the aircraft, the services required at an airfield for that airfield to be able to service the aircraft, current location of the aircraft, fuel capacity of the aircraft, and the current fuel load of the aircraft. The data received by the computing system may also include data associated with airfields. Examples of such data are: opening times of the airfield, airfield fees, available services of the airfield, type of runway of the airfield (for example tarmac or grass), length of runway of the airfield, size of the airfield's hangers, and maximum take-off weight.

At step 204, the received data is stored in database 106. The received data is updated periodically. The database 106 may overwrite stored parameter values with newly received values for those same parameters. For example, the database may constantly receive the real-time location of an aircraft. Suitably, the previous value of the location of the aircraft is over-written with the new value of the location of the aircraft.

At step 206, the computing system receives a transport request from a user. This transport request is a request to charter one or more passengers from a requested origin to a requested destination in time frame T. The requested origin may, for example, be any of the following location types: a zip code, an airfield or a geographical area, such as a city. The requested destination may, for example, be any of the following location types: a zip code, an airfield or a geographical area, such as a city. The location type of the requested origin may be the same or different to the location type of the requested destination.

The time frame T may be a specific date for the flight. Alternatively, the time frame T may span over more than one day. The time frame T may be a time window bounded by an earliest departure time from the requested origin. The time frame T may be a time window bounded by a latest departure time from the requested origin. The time frame T may be a time window bounded by a latest arrival time at the requested destination. The time frame T may be a time window bounded by the earliest arrival time at the requested destination. The time frame T may be a time window bounded at both ends, for example by an earliest departure time and a latest arrival time. The time frame T may be a time window bounded by time of day, for example afternoon.

Having received the transport request at step 206, the computing system moves onto step 208 in which it compares the transport request with the data stored in database 106 and, based on selection criteria, selects one or more preferred aircraft of the set of aircraft to service the transport request. The computing system may assess each aircraft of the set of aircraft against the selection criteria, and select the one or more aircraft which best meet the selection criteria to be the preferred aircraft. The computing system may apply predetermined relative weights to the selection criteria when selecting the preferred aircraft. For example, each selection criterion may be allocated a maximum number of points. The maximum number of points allocated to different selection criterion differs, with more important selection criteria being allocated more points. Each aircraft is scored for each selection criterion out of the maximum number of points allocated to that selection criterion. Each aircraft is scored for each selection criterion based on how well that aircraft achieves the requirements of the selection criterion. Suitably, the aircraft selected to be the preferred aircraft are those which have the highest number of points in total from all the selection criteria.

One selection criterion is whether the aircraft is capable of servicing the transport request whilst still performing its required loaded periods. In order to be selected as a preferred aircraft, the aircraft must have a replaceable unloaded period of its transit schedule during which it is able to service a flight from the requested origin to the requested destination during time frame T. To determine which aircraft of the set of aircraft are able to service the transport request whilst still performing the mandatory required loaded periods of their transit schedules, the computing system may perform the following method for each aircraft. This method is described with reference to FIG. 3:
1. Determine the flight time from the requested origin to the requested destination for that aircraft T_{f}.
2. Determine if the transit schedule of that aircraft has a replaceable unloaded period during time frame T in which the aircraft is scheduled to transit from a scheduled origin to a scheduled destination.
3. If the answer to step 2 is yes, determine the flight time Tₒ from the scheduled origin A to the requested origin C, and determine the flight time T_{d} from the requested destination D to the scheduled destination B.
4. Determine if the aircraft has enough time to fly from the scheduled origin A to the requested origin C to the requested destination D to the scheduled destination B in the time Tᵢ in between the end of one of the aircraft's required loaded periods and the beginning of the next one of the aircraft's required loaded periods. In other words, determine if Tₒ+T_{f}+T_{d}≦T₁.
5. If the answer to step 4 is yes, determine if the aircraft is able to fly from the scheduled origin A to the requested origin C to the requested destination D to the scheduled destination B in the replaceable unloaded period and with the flight from the requested origin C to the requested destination D being within time frame T.

If the answer to step 5 is yes, then that aircraft is able to service the transport request whilst still performing its mandatory required loaded periods of its transit schedule. As can be seen from FIG. 3, the replaceable unloaded period Tᵢ of an aircraft's transit schedule does not need to wholly coincide with time frame T in order for the aircraft to be able to service the requested flight. In the example of FIG. 3, the latest time tₗ that the aircraft can arrive at the requested destination is t_{B}−T_{d}. The earliest time tₑ that the aircraft can leave the requested origin is t_{A}+Tₒ. In this case, in order for the aircraft to be able to service the requested flight, the time frame tₗ−tₑ needs to overlap time frame T by at least the flight time T_{f} of the requested flight. In other examples, tₗ and/or tₑ may be affected by other criteria. For example, airfields at the requested origin C and/or the requested destination D may not be open 24 hours a day. Thus, the latest time tₗ that the aircraft can arrive at an airfield at the requested destination D may be before t_{B}−T_{d}. Specifically, tₗ may be the latest time that the aircraft is able to land at the airfield which still enables it to set off from the airfield before the airfield closes to arrivals and departures. The earliest time tₑ that the aircraft can leave the requested origin C may be after t_{A}−Tₒ. Specifically, tₑ may be the earliest time that the aircraft is able to take off from the airfield after the airfield opens to arrivals and departures, having already had time to land after the airfield opened to arrivals.

Whilst the method above has been presented as a five step method, it will be appreciated that these steps could be performed in a different order. One or more of the steps could be amalgamated.

Another selection criterion is minimising additional transit time for servicing the requested flight over the empty leg of the replaceable unloaded period. In order to assess this, the computing system may perform the following method. The computing system determines the scheduled transit time Tₛ for the aircraft to transit from the scheduled origin to the scheduled destination. The computing system determines an amended transit time Tₒ+T_{f}+T_{d} for the aircraft to transit from the scheduled origin to the requested origin to the requested destination to the scheduled destination. The computing system computes the difference between the amended transit time and the scheduled transit time to give the additional transit time.

The requested origin may be the same as the scheduled origin. In this case, there is no additional flight time for transiting between the scheduled origin and the requested origin. In other words, Tₒ=0. The requested destination may be the same as the scheduled destination. In this case, there is no additional flight time for transiting between the requested destination and the scheduled destination. In other words, T_{d}=0.

Another selection criterion is whether the aircraft is capable of being serviced by an airfield which is proximal to the requested origin, and whether the aircraft is capable of being serviced by an airfield which is proximal to the requested destination. For example, in order to be selected as a preferred aircraft, the aircraft has to be serviceable by an airfield which is located within a distance X of the requested origin and also serviceable by an airfield which is located within a distance Y of the requested destination. X may be less than 50 km. X may be less than 25 km. X may be 40 km. Y may be less than 50 km. Y may be less than 25 km. Y may be 40 km. Some airfield limitations enable them to service some aircraft but not others. For example, an airfield may have a runway which is suitable for small aircraft but not for larger aircraft. For example, the runway may be too short for some aircraft to take-off, the runway may be grass which is unsuitable for some aircraft, and/or the runway may have a maximum take-off weight which is lighter than some aircraft. The airfield may have hangers which are too small for some aircraft.

Further exemplary selection criteria include the size of the aircraft, and the services available on the aircraft.

The aircraft must have a replaceable unloaded period of its transit schedule during which it is able to service a flight from the requested origin to the requested destination in the time frame T in order to be selected as a preferred aircraft. The aircraft must be capable of being serviced by an airfield which is proximal to the requested origin, and must be capable of being services by an airfield which is proximal to the requested destination in order to be selected as a preferred aircraft. Any one or more of the other selection criteria described above may be used to select the aircraft.

Step 208 may further comprise, for each aircraft, identifying a departure airfield and a destination airfield that that aircraft would fly between to service the requested flight. To do this, the computing system identifies a set of departure airfields which are proximal to the requested origin, and a set of destination airfields which are proximal to the requested destination. For example, the set of departure airfields may comprise those airfields which are within a distance X of the requested origin. X may be less than 50 km. X may be less than 25 km. X may be 40 km. For example, the set of destination airfields may comprise those airfields which are within a distance Y of the requested destination. Y may be less than 50 km. Y may be less than 25 km. Y may be 40 km.

Having identified a set of departure airfields, the computing system goes on to select a departure airfield based on selection criteria. Having identified a set of destination airfields, the computing system goes on to select a destination airfield based on selection criteria. Suitably, the selection criteria for the departure airfield and the destination airfield are the same. The computing system may apply predetermined relative weights to the selection criteria when selecting the airfields. For example, each selection criterion may be allocated a maximum number of points. The maximum number of points allocated to different selection criterion differs, with more important selection criteria being allocated more points. Each airfield is scored for each selection criterion out of the maximum number of points allocated to that selection criterion. Each airfield is scored for each selection criterion based on how well that airfield achieves the requirements of the selection criterion. Suitably, the airfield selected is that which has the highest number of points in total from all the selection criteria.

One selection criterion is whether the aircraft can be serviced at that airfield between tₑ and tₗ. To assess this selection criterion, the computing system may determine any one or more of the following: whether the airfield is open between tₑ and tₗ, whether the airfield has runways which are suitable for the aircraft to land on and take off from, whether the airfield has a suitable hanger for the aircraft to wait in, whether the aircraft will need refuelling and if so whether the airfield is able to refuel it.

Another selection criterion may be minimising the distance between the requested origin/destination and the departure/destination airfield. The shorter the distance between the requested origin/destination and the departure/destination airfield, the better the airfield performs against this selection criterion.

Another selection criterion may be the services the airfield provides for the passengers. The better services the airfield provides, the better the airfield performs against this selection criterion.

Another selection criterion may be the fees associated with staying at that airfield. These fees are stored in database 106 and may include airfield handling fees, government fees etc. These fees may have been provided to computing system 102 from aircraft operators 110 and/or direct from the airfields.

The aircraft must be serviceable at the airfield between tₑ and tₗ in order for an airfield to be selected as a departure airfield or a destination airfield. Any one or more of the other selection criteria described above may be used to select the airfield. More weight may be applied to one selection criterion than another. The relative weights applied to the other selection criteria may differ for different aircraft. For example, for large aircraft, more importance may be applied to minimising the distance between the requested origin/destination and the departure/destination airfield than to the fees associated with staying at the airfield.

Having selected a departure airfield and a destination airfield, the selection criterion for selecting a preferred aircraft which is minimising the additional transit time for servicing the requested flight over the empty leg of the replaceable unloaded period can be determined by computing the difference between an amended transit time and the scheduled transit time, where the amended transit time is the time for the aircraft to transit from the scheduled origin to the departure airfield to the destination airfield to the scheduled destination.

At step 208, the computing system may assess all the aircraft in the set of aircraft against all of the selection criteria to select the preferred aircraft.

Alternatively, at step 208, the computing system may apply the selection criteria in one or more steps, and after each step filter the number of aircraft to be assessed against the selection criteria of the next step based on how the aircraft performed against the selection criteria of the last step.

For example, the computing system may initially assess all the aircraft in the set of aircraft to determine which aircraft have replaceable unloaded periods of their transit schedules during which they are able to service a flight from the requested origin to the requested destination in the time frame T. Only those aircraft which have replaceable unloaded periods of their transit schedules during which they are able to service a flight from the requested origin to the requested destination in the time frame T are assessed against the next selection criterion.

The next selection criterion may be whether the aircraft are capable of being serviced by an airfield which is proximal to the requested origin and by an airfield which is proximal to the requested destination. Only those aircraft which satisfy this criterion are assessed against the next selection criterion.

The next selection criterion may be minimising additional transit time for servicing the requested flight over the empty leg of the replaceable unloaded period. At this stage the computing system may select the departure airfield and destination airfield as described above for each remaining aircraft following the previous selection criterion, and then compute the difference between the amended transit time and the scheduled transit time, the amended transit time being that taken to transit from the scheduled origin to the departure airfield to the destination airfield to the scheduled destination. The preferred aircraft may then be selected to be those with the minimum additional transit time.

Alternatively, the computing system may perform further filtering steps. For example, at this stage, the next selection criterion may be minimising additional transit time for servicing the requested flight over the empty leg of the replaceable unloaded period, but the amended transit time being that taken to transit from the scheduled origin to the requested origin to the requested destination to the scheduled destination. Only a subset of aircraft with the lowest additional transit time are assessed against the next selection criterion. Alternatively, only those aircraft which have an additional transit time below a predetermined threshold are assessed against the next selection criterion. That predetermined threshold may, for example, be double the scheduled transit time.

Alternatively, for each aircraft type, only a subset of aircraft with the lowest additional transit times are assessed against the next selection criterion. Aircraft may be designated into different aircraft types by speed, size, passenger capacity, engine type (e.g. propeller or jet), age of plane, brand, seating configuration and/or other on board passenger amenities available. The subset for each aircraft type may consist of N aircraft. N may, for example, be 3.

The next selection criterion may then be minimising additional transit time for servicing the requested flight over the empty leg of the replaceable unloaded period. At this stage the computing system selects the departure airfield and destination airfield as described above for each remaining aircraft following the previous selection criterion, and then computes the difference between the amended transit time and the scheduled transit time, the amended transit time being that taken to transit from the scheduled origin to the departure airfield to the destination airfield to the scheduled destination. The preferred aircraft may then be selected to be those with the minimum additional transit times.

By applying the selection criteria in several steps and filtering the number of aircraft assessed against the selection criteria at each step, the overall selection mechanism is less computationally complex. For a given processing power, this enables the preferred aircraft to be selected more quickly.

Once the one or more preferred aircraft have been selected at step 208, the preferred aircraft are transmitted to the user device 114 via the internet 108. The user selects one of the preferred aircraft and transmits this request to the computing system. The computing system responds at step 210 by changing the flight path of the selected preferred aircraft to service the transport request. Thus, the flight path of the selected preferred aircraft is changed from transiting from the scheduled origin to the scheduled destination during the replaceable unloaded period to transiting from the scheduled origin to the departure airfield to the destination airfield to the scheduled destination during the replaceable unloaded period, with the transit between the departure airfield and the destination airfield occurring during the time frame T. The computing system sends the flight path change instruction to the aircraft operator 110, which updates the flight path of the aircraft.

The flight path of the preferred aircraft may be changed prior to the empty leg of that aircraft. In this case, the flight path of the preferred aircraft is changed before the aircraft has started its scheduled transit from the scheduled origin to the scheduled destination during the replaceable unloaded period. Alternatively, the flight path of the preferred aircraft may be changed during the replaceable unloaded period of the preferred aircraft. In this case, the aircraft may be located at the scheduled origin at the time that its flight path is changed. Alternatively, the aircraft may be in transit between the scheduled origin and the scheduled destination at the time that its flight path is changed. Suitably, the computing system receives real-time data from the aircraft operators 110 of aircraft in transit, such as the current location of the aircraft and the current fuel load of the aircraft. With this data, the computing system is able to determine in real-time which aircraft of the set, including those currently airborne on empty legs, are able to service the transport request from the user.

The apparatus and methods described herein enable the environmental impact of private aviation to be reduced by maximising the number of empty leg flights which are converted into passenger bearing flights. By enabling empty legs to be partially converted into passenger bearing flights, the number of air miles flown with no passengers on board is reduced, thus the carbon footprint of empty flights is reduced.

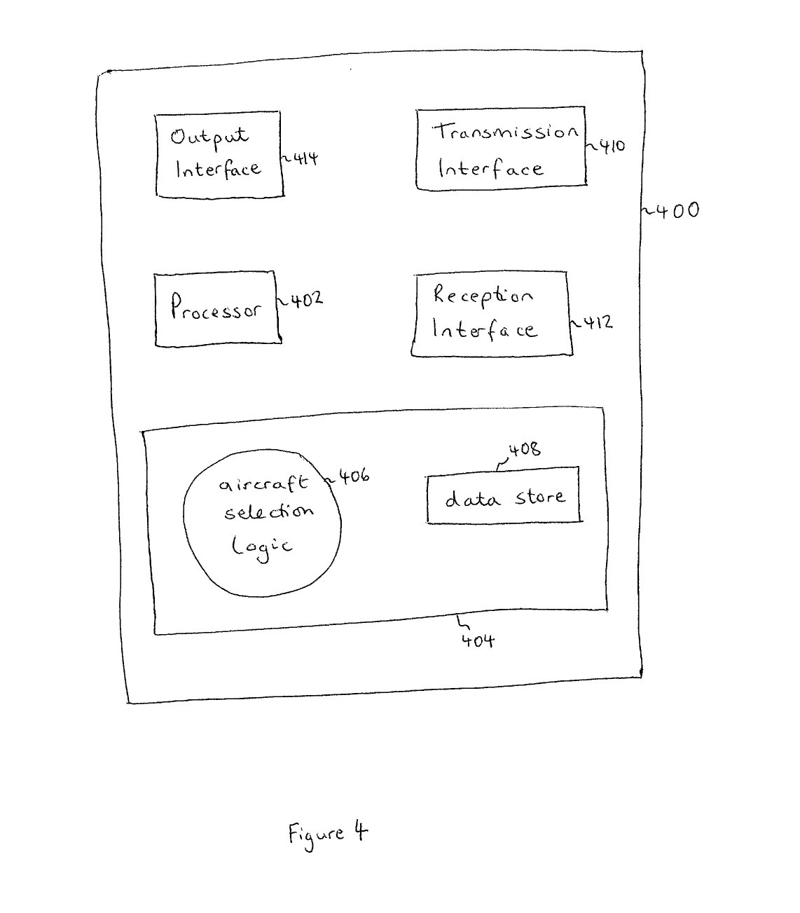

Reference is now made to FIG. 4. FIG. 4 illustrates a computing-based device 400 in which computing system 102 can be implemented. The computing-based device may be an electronic device. The computing-based device illustrates functionality for receiving aircraft data, storing aircraft data, receiving a transport request, computing preferred aircraft based on selection criteria, and changing the flight path of a preferred aircraft.

Computing-based device 400 comprises a processor 402 for processing computer executable instructions configured to control the operation of the device in order to perform the methods described herein. The computer executable instructions can be provided using any computer-readable media such as memory 404. Further software that can be provided at the computer-based device 400 includes aircraft selection logic 406 which implements step 208 of FIG. 2. Alternatively, the aircraft selection logic 406 is implemented partially or wholly in hardware. Data store 408 may store data such as aircraft data including transit schedules. Computing-based device 400 further comprises a transmission interface 410 which transmits the one or more preferred aircraft to the user device and transmits a flight path change instruction to the aircraft operator. Computing-based device 400 further comprises a reception interface 412 which receives transport requests from user devices. Computing-based device 400 also comprises an output interface 414. FIG. 4 illustrates a single computing-based device in which the computing system 102 is implemented. However, the functionality of the computing system 102 may be implemented on separate computing-based devices.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method of changing the flight path of an aircraft, the aircraft being one in a set of aircraft, each aircraft in the set having a flight path in accordance with a transit schedule, the transit schedule including required loaded periods and replaceable unloaded periods, the method comprising:
receiving data associated with the set of aircraft, the received data including the transit schedule of each aircraft;
storing the received data in a database;
receiving a request to transport a load from a requested origin to a requested destination in time frame T;
comparing, at a processor, the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and
changing the flight path of one of the preferred aircraft to transit from the scheduled origin to the requested origin to the requested destination to the scheduled destination during the replaceable unloaded period.

2. The method of claim 1, wherein each preferred aircraft is capable of flying from the scheduled origin to the requested origin to the requested destination to the scheduled destination during the replaceable unloaded period of that aircraft, wherein the transit between the requested origin and the requested destination is within the time frame T.

3. The method of claim 1, wherein each preferred aircraft is capable of being serviced by an airfield proximal to the requested origin and is capable of being serviced by an airfield proximal to the requested destination.

4. The method of claim 1, wherein the requested origin is the scheduled origin.

5. The method of claim 1, wherein the requested destination is the scheduled destination.

6. The method of claim 1, further comprising:
identifying a set of departure airfields proximal to the requested origin;
identifying a set of destination airfields proximal to the requested destination;
selecting a departure airfield of the set of departure airfields based on selection criteria including minimising the distance between the requested origin and the departure airfield; and
selecting a destination airfield of the set of destination airfields based on selection criteria including minimising the distance between the requested destination and the destination airfield.

7. The method of claim 6, wherein the selection criteria for selecting the departure airfield further include the ability of the departure airfield to service the one preferred aircraft, and wherein the selection criteria for selecting the destination airfield further include the ability of the destination airfield to service the one preferred aircraft.

8. The method of claim 6, wherein the amended transit time is the time for the aircraft to transit from the scheduled origin to the selected departure airfield to the selected destination airfield to the scheduled destination.

9. The method of claim 1, wherein the requested origin and/or requested destination comprise a geographical area.

10. The method of claim 1, wherein the requested origin and/or requested destination comprise a zip code.

11. The method of claim 1, wherein the requested origin and/or requested destination comprise an airfield.

12. The method of claim 1, wherein the time frame T is bounded by an earliest departure time.

13. The method of claim 1, wherein the time frame T is bounded by a latest arrival time.

14. The method of claim 1, comprising changing the flight path of the one preferred aircraft prior to the replaceable unloaded period of the one preferred aircraft.

15. The method of claim 1, comprising changing the flight path of the one preferred aircraft during the replaceable unloaded period whilst the one preferred aircraft is in flight from the scheduled origin to the scheduled destination.

16. The method of claim 15, wherein the received data includes the current location of the aircraft in transit.

17. An apparatus for changing the flight path of an aircraft, the aircraft being one in a set of aircraft, each aircraft in the set having a flight path in accordance with a transit schedule, the transit schedule including required loaded periods and replaceable unloaded periods, the apparatus comprising:
a receiver configured to receive data associated with the set of aircraft, the received data including the transit schedule of each aircraft, the receiver being further configured to receive a request to transport a load from a requested origin to a requested destination in time frame T;
a database configured to store the received data; and
a processing system, coupled to the receiver and the database, the processing system including a processor and a memory coupled to the processor, the memory storing computer executable instructions, the processor being configured to execute the computer executable instructions to:
comparing the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and
changing the flight path of one of the preferred aircraft to transit from the scheduled origin to the requested origin to the requested destination to the scheduled destination during the replaceable unloaded period.

18. The apparatus of claim 17, wherein the processor is further configured to execute the computer executable instructions to:
identify a set of departure airfields proximal to the requested origin;
identify a set of destination airfields proximal to the requested destination;
select a departure airfield of the set of departure airfields based on selection criteria including minimising the distance between the requested origin and the departure airfield; and
select a destination airfield of the set of destination airfields based on selection criteria including minimising the distance between the requested destination and the destination airfield.

19. A non-transitory computer readable medium with computer executable instructions stored thereon, which, when executed by a processor perform a method of causing a flight path of an aircraft to be changed, the method comprising:
receiving data associated with the set of aircraft, the received data including a transit schedule of each aircraft;
storing the received data in a database;
receiving a request to transport a load from a requested origin to a requested destination in time frame T;
comparing the received request with the received data so as to select one or more preferred aircraft from the set of aircraft, each preferred aircraft having a replaceable unloaded period at time frame T during which that aircraft is scheduled to transit from a scheduled origin to a scheduled destination, the one or more preferred aircraft being selected based on selection criteria including minimising the difference between a scheduled transit time for the aircraft to transit from the scheduled origin to the scheduled destination and an amended transit time for the aircraft to transit from the scheduled origin to the requested origin to the requested destination to the scheduled destination; and
causing a change in the flight path of one of the preferred aircraft to transit from the scheduled origin to the requested origin to the requested destination to the scheduled destination during the replaceable unloaded period.

20. The non-transitory computer readable medium of claim 19, further comprising identifying a set of departure airfields proximal to the requested origin;
identifying a set of destination airfields proximal to the requested destination;
selecting a departure airfield of the set of departure airfields based on selection criteria including minimising the distance between the requested origin and the departure airfield; and
selecting a destination airfield of the set of destination airfields based on selection criteria including minimising the distance between the requested destination and the destination airfield.
